(19) United States
(12) Patent Application Publication
(10) Pub. No.: US 2024/0335688 A1
(43) Pub. Date: Oct. 10, 2024

(54) SPRINKLER HEAD DEVICE FOR REMOVAL OF SMOKE AND TOXIC GAS EQUIPPED WITH ROTARY VENTURI

(71) Applicant: SP&E CO. LTD., Seoul (KR)

(72) Inventor: Sung Woo KIM, Osan-si, Gyeonggi-do (KR)

(73) Assignee: SP&E CO. LTD., Seoul (KR)

(21) Appl. No.: 18/294,392

(22) PCT Filed: Mar. 25, 2022
(86) PCT No.: PCT/KR2022/004192

§ 371 Date: Feb. 1, 2024

(30) Foreign Application Priority Data
Aug. 2, 2021 (KR) 10-2021-0101361
Mar. 24, 2022 (KR) 10-2022-0036501

(51) Int. Cl. A62C 31/02; A62C 99/00; B05B 1/34

(52) U.S. Cl. CPC A62C 31/02; A62C 99/0072; B05B 1/3415

(57) ABSTRACT

Disclosed herein is a sprinkler head device for removal of smoke and toxic gas equipped with a rotary venturi, which includes a nozzle configured to spray water supplied from the outside, a venturi casing configured to receive the water sprayed from the nozzle to allow the same to pass therethrough in a state in which it is rotatably supported by the nozzle, to generate negative pressure while the water passes therethrough to suck ambient gas, and to mix the sucked gas with the water to discharge a mixture thereof, a rotary vane fixed to the inside of the venturi casing and configured to transmit rotational force to the venturi casing by means of kinetic energy received from water, and a press-fit vane positioned at the venturi casing and configured to draw in ambient gas and press the same into the venturi casing when the venturi casing rotates.

### TECHNICAL FIELD

The present disclosure relates to a sprinkler for simultaneous removal of smoke and toxic gas, and more particularly, to a sprinkler head device for removal of smoke and toxic gas equipped with a rotary venturi, which is capable of using kinetic energy of water sprayed in the event of a fire to suck smoke and toxic gas in the vicinity thereof, dissolve the same in water, and spray the same at the same time, thereby performing extinguishing and toxic gas removal at once.

### BACKGROUND ART

Recent buildings are compulsorily equipped with various fire-fighting facilities that meet the standards prescribed by the strengthened Fire Services Act. Examples of these fire-fighting facilities include fire-extinguishing facilities, alarm facilities, evacuation facilities, fire-fighting water facilities, and facilities related to fire-extinguishing activities. In recent years, a facility such as a smoke control system or a sprinkler with better performance and no malfunction has been developed for application. Of course, the fire-fighting facilities have a common purpose of minimizing human casualties by detecting and extinguishing a fire in early stages.

Among the facilities mentioned above, the sprinkler is an automatic fire-extinguishing facility that spouts fire-fighting water in the event of a fire. It is usually placed on the ceiling of a building and used to extinguish a fire by radially spraying water supplied through a standpipe and a branch pipe.

There are many different types of sprinklers, including closed and open sprinklers. The closed sprinkler is of a type in which a heat sensitive part is installed and has a normally closed spray nozzle. On the other hand, the open sprinkler has no heat sensitive part and an open spray nozzle. Examples of the closed sprinkler also include melt-type and burst-type sprinklers. The melt-type sprinkler is configured to spray water by melting its fuse metal at an operating temperature and eliminating it. The burst-type sprinkler is configured to spray water by breaking its glass bulb at an operating temperature and eliminating it.

Meanwhile, the smoke and toxic gas generated at the site of a fire gather on the ceiling thereof by means of buoyancy due to heat, and gradually form airflow. For example, they spread in a less hot direction, which is the direction of low pressure, on the ceiling surface, thereby gradually forming a thick layer and finally filling the room. Heat and pressure cause a flow of smoke and toxic gas.

The hot smoke generated by the fire continuously rises by its buoyancy and flows to increase the pressure in the upper part of the room, and smoke (unburned combustible gas) flows to the place with low pressure. Consequently, the fire spreads due to the flashover phenomenon, which is ignited at a certain critical point by radiant heat.

A conventional sprinkler may extinguish flames to some extent (since it sprays water), but does not remove smoke and toxic gas. This is because, when water is sprayed, the hot smoke and toxic gas in the upper part of the room are concentrated through cooling by the water while descending. The descending smoke and toxic gas create a suffocation environment and completely block visibility such that no escape can be found, which causes a so-called smoke-logging environment. The concentrated toxic gas that is laid on the floor suffocates people to be rescued within seconds and blocks their view, making it almost impossible to escape.

FIG. 1 is a view for explaining a smoke-logging phenomenon that occurs in the event of a fire.

As illustrated in A) and B) of FIG. 1, in the early stage of a fire, hot smoke and toxic gas continuously rise and gather to the upper part of the indoor space to increase the pressure therein, and smoke and toxic gas (unburned combustible gas) ignite while spreading in a direction of low pressure. Consequently, the fire spreads to the surrounding area due to the flashover phenomenon.

In this state, when a sprinkler operates to spray fire-fighting water, the toxic gas is cooled and concentrated by the fire-fighting water and begins to descend, as illustrated in C) of FIG. 1. As a result, as illustrated in D) of FIG. 1, both upper and lower parts of the indoor space are completely dark, and the concentration of poison gas increases over time in a state of blackout due to the fire. In a dark situation where one cannot see the front, a person to be rescued falls into a panic to breathe three times faster in breathing, and inhales toxic gas at a high rate, resulting in loss of judgment, entanglement, and suffocation without being able to escape. For reference, if a person is exposed to toxic gas for 10 to 15 seconds in the event of a fire, the person will become unconscious, and will die from just one or two sips of hydrogen cyanide (HCN) gas, which is produced in large quantities during the fire.

In addition, even if an exhaust system that exhausts toxic gas is actuated, it takes a long time (much more than people can hold their breath) to exhaust the smoke and toxic gas filling the inside of the building and make it breathable. Hence, it is impossible to keep the golden time for people to evacuate safely.

Efforts are required to reduce the lethal dose of toxic gas to a safe range or less within a short period of time by a device that removes the toxic gas itself in the room.

### DISCLOSURE

### Technical Problem

Various embodiments are directed to a sprinkler head device for removal of smoke and toxic gas equipped with a rotary venturi, which is capable of sucking and removing ambient smoke and toxic gas at the same time while spraying water in the event of a fire to reduce a lethal dose of toxic gas as much as possible to a safe range within a short period of time, and of ensuring visibility to minimize human casualties.

### Technical Solution

In an embodiment, there is provided with a sprinkler head device for removal of smoke and toxic gas equipped with a rotary venturi, which includes a nozzle configured to spray water supplied from the outside, a venturi casing configured to receive, through an inlet part thereof, the water sprayed from the nozzle to allow the same to pass therethrough in a state in which the venturi casing is rotatably supported by the nozzle, to generate negative pressure according to a Venturi effect while the water passes therethrough to suck ambient gas, and to mix the sucked gas with the water to discharge a mixture thereof, a rotary vane fixed to the inside of the venturi casing and configured to transmit rotational force to the venturi casing by means of kinetic energy received from water, and a press-fit vane positioned at an upstream end of the venturi casing and configured to draw in ambient gas and press the same into the venturi casing when the venturi casing rotates.

The sprinkler head device may further include a nozzle latch ring fixed to the upstream end of the venturi casing via the press-fit vane, the nozzle latch ring being in the form of a ring and being is rotatably latched to and supported by the nozzle while wrapping the nozzle.

The sprinkler head device may further include a push-up vane provided on an outer peripheral surface of the venturi casing to guide gas around the venturi casing toward the inlet part of the venturi casing.

The venturi casing may be composed of an upper casing and a lower casing that are assembled to each other.

The lower casing may be partially accommodated inside the upper casing, and then extend outward of the upper casing by the action of hydraulic pressure when water is sprayed.

The upper casing may have a spiral groove formed thereon to extend spirally. The lower casing may have a groove insertion protrusion formed to be movable along the spiral groove in a state in which the groove insertion protrusion is fitted into the spiral groove.

In another embodiment, there is provided with a sprinkler head device for removal of smoke and toxic gas equipped with a rotary venturi, which includes a nozzle configured to spray water supplied from the outside, a venturi casing supported by the nozzle, and configured to allow the water sprayed from the nozzle to pass therethrough, to generate negative pressure according to a Venturi effect while the water passes therethrough to suck ambient gas, and to mix the sucked gas with the water to discharge a mixture thereof, wherein the venturi casing has a fixed casing fixed to the nozzle and providing an inlet for introducing gas therethrough, and a rotating casing rotatably coupled to the fixed casing, and a rotary vane fixed to the inside of the rotating casing and configured to rotate the rotating casing by means of kinetic energy received from the water sprayed from the nozzle.

The fixing casing may have a rotating ring formed on an outer peripheral surface thereof to extend in a circumferential direction of the fixed casing. The rotating casing may have a ring accommodation groove provided on an inner peripheral surface thereof to accommodate the rotating ring and receive support force from the rotating ring.

The nozzle may have a built-in vortex inductor therein for swirling a flow of water passing through the nozzle.

### Advantageous Effects

According to the embodiments, a sprinkler head device for removal of smoke and toxic gas equipped with a rotary venturi can suck and remove ambient smoke and toxic gas at the same time while spraying water in the event of a fire to reduce a lethal dose of toxic gas as much as possible to a safe range within a short period of time, and can ensure visibility to minimize human casualties.

### BRIEF DESCRIPTION OF DRAWINGS

FIG. 1 is a view for explaining a smoke-logging phenomenon that occurs when a conventional sprinkler operates in the event of a fire.

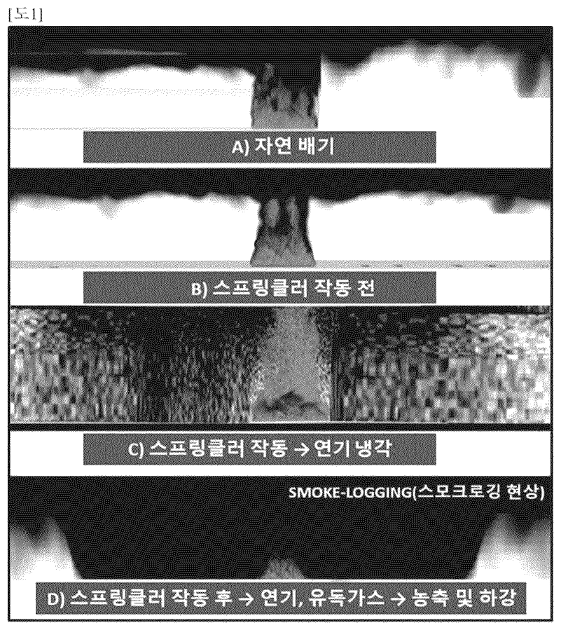

FIGS. 2(a) to 2(c) are views illustrating a configuration of a sprinkler head device according to a first embodiment of the present disclosure.

FIGS. 3(a) to 3(c) are views illustrating modification of the sprinkler head device according to the first embodiment of the present disclosure.

FIG. 4 is a view for explaining a mounting structure of a nozzle on the sprinkler head device according to the first embodiment of the present disclosure.

FIGS. 5(a) and 5(b) are views illustrating another modification of the sprinkler head device according to the first embodiment of the present disclosure.

FIGS. 6(a) and 6(b) are views illustrating an exemplary use of the sprinkler head device illustrated in FIG. 5(a).

FIGS. 7(a) to 7(d) are views illustrating a configuration of a sprinkler head device according to a second embodiment of the present disclosure.

FIG. 8 is a view for explaining an operation of the sprinkler head device illustrated in FIG. 7(a).

FIGS. 9(a) to 9(f) are views illustrating an internal configuration of the nozzle applicable to the sprinkler head devices according to the first and second embodiments of the present disclosure.

FIG. 10 is a view illustrating another modification of the vortex inductor illustrated in FIG. 9.

### MODE FOR DISCLOSURE

Hereinafter, an exemplary embodiment of the present disclosure will be described in detail with reference to the accompanying drawings.

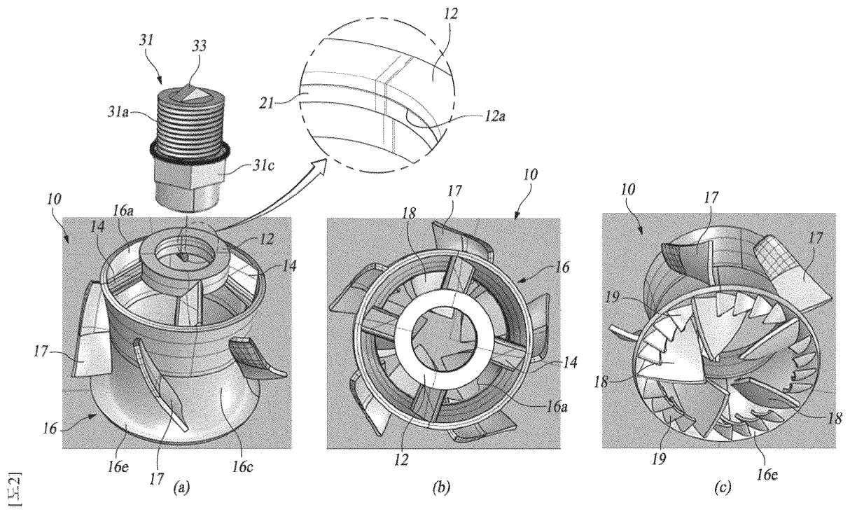

FIGS. 2(a) to 2(c) are views illustrating a configuration of a sprinkler head device according to a first embodiment of the present disclosure. FIG. 2(a) is a perspective view of the sprinkler head device which is designated by reference numeral 10, and FIG. 2(b) is a bottom view thereof. FIG. 2(c) is a bottom perspective view of the sprinkler head device 10.

As illustrated in the drawings, the sprinkler head device 10 for removal of smoke and toxic gas equipped with a rotary venturi according to the present embodiment includes a nozzle 31, a nozzle latch ring 12, a bearing 21, and a venturi casing 16, first and second rotary vanes 18 and 19, a press-fit vane 14, and a push-up vane 17.

The nozzle 31 allows the water supplied from the outside to be sprayed downward therethrough. Various types of nozzles may be used as long as they can function to spout water. Examples of the nozzle herein include a nozzle for a closed sprinkler and a nozzle for an open sprinkler.

For convenience, the nozzle is illustrated as a nozzle for an open sprinkler in the drawings for explanation of the present embodiment and a second embodiment to be described later. However, a nozzle for a closed sprinkler is also applicable to the present disclosure.

For reference, the nozzle of the closed sprinkler is of a type in which a heat sensitive part is installed and is normally closed. On the other hand, the nozzle of the open sprinkler has no heat sensitive part and has an open configuration. In the event of a fire, the heat sensitive part installed in the nozzle of the closed sprinkler is crushed by the pressure of water through the nozzle, and the crushed fragments exit immediately down the venturi casing.

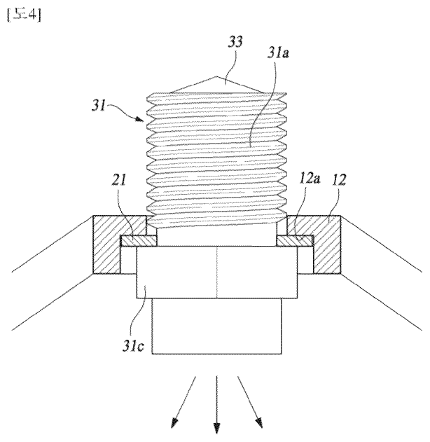

The nozzle 31 is connected to the end of a fire-fighting pipe, and allows the water supplied through the pipe to be sprayed downward therethrough. The nozzle 31 has an engaging screw part 31a and a torque input part 31c. The engaging screw part 31a is a portion that is screwed to the fire-fighting pipe, and the torque input part 31c is a hexagonal portion that is fastened to a clamping tool when the nozzle 31 is fixed. The hexagonal edge of the torque input part 31c protrudes radially from the engaging screw part 31a. Accordingly, as illustrated in FIG. 4, the nozzle latch ring 12 may be supported by the torque input part 31c.

The nozzle 31 has a built-in vortex inductor 33 therein. The vortex inductor 33 swirls the flow of water passing through the nozzle 31. That is, it is to make the streamline of water spiral. This is to improve the mixing efficiency of water and gas by spreading the spouted water widely.

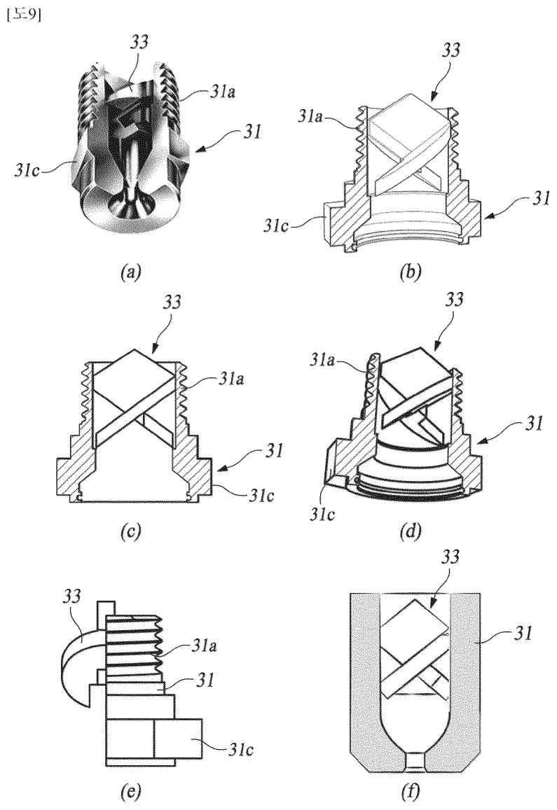

FIGS. 9(a) to 9(f) are views illustrating the nozzle 31 and a state in which the vortex inductor 33 is mounted in the nozzle 31.

As illustrated in the drawings, different shaped vortex inductors 33 are installed in the nozzle 31. As mentioned above, the vortex inductor 33 swirls the water passing through the nozzle 31. The shape or material of the vortex inductor 33 may be implemented in various ways as long as the vortex inductor 33 performs the above function.

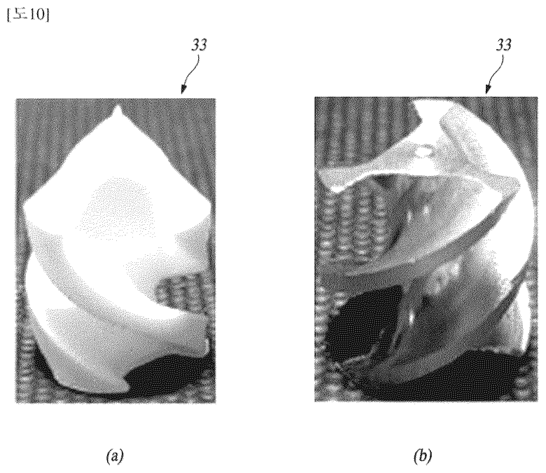

For example, as illustrated in FIGS. 10(a) and 10(b), the vortex inductor 33 itself may be manufactured in the form of a screw. The vortex inductor may be made of a material such as synthetic resin or metal.

The venturi casing 16 is a cylindrical member that is installed beneath the nozzle and is open vertically, and has an inlet part 16a, an acceleration part 16c, and an outlet part 16e. The inlet part 16a is a portion that flares upward, and the acceleration part 16c is a narrow portion. In addition, the outlet part 16e is a portion that flares downward.

The acceleration part 16c has an inner diameter smaller than the inner diameters of the inlet part 16a and the outlet part 16e. The acceleration part 16c includes a portion of the venturi casing 16 having the smallest flow sectional area. Thus, the water sprayed from the nozzle 31 is accelerated while passing through the acceleration part. As the water accelerates, it goes without saying that negative pressure is generated by the Venturi principle.

That is, the venturi casing 16 allows the water sprayed from the nozzle to pass therethrough via the nozzle latch ring 12 and the press-fit vane 14 in a state in which the venturi casing 16 is rotatably latched by the nozzle 31, and generates negative pressure according to the Venturi effect. The generated negative pressure is lower than the surrounding atmospheric pressure, and allows ambient gas to be sucked into the venturi casing 16.

As illustrated in FIG. 4, the nozzle latch ring 12 is a ring-shaped member that is latched to the torque input part 31 of the nozzle 31, and has a latch groove 12a. The latch groove 12a is a groove that accommodates the upper edge of the torque input part 31c. In addition, the bearing 21 is installed inside the latch groove 12a. The bearing 21 is a ring-shaped member made of synthetic resin, and prevents friction between the nozzle 31 and the nozzle latch ring 12. The bearing 21 can be made of acetal.

A plurality of press-fit vanes 14 are positioned between the nozzle latch ring 12 and the top of the venturi casing 16. The press-fit vanes 14 are symmetrical to each other with the nozzle latch ring 12 centered therebetween. The press-fit vanes 14 serve to draw in ambient gas and press it into the venturi casing when the venturi casing 16 rotates, and also serve to connect the nozzle latch ring 12 and the venturi casing 16. The venturi casing 16 is connected to the nozzle latch ring 12 through the press-fit vanes 14.

The first and second rotary vanes 18 and 19 are a plurality of vane members fixed to the inside of the bottom of the venturi casing 16, and transmit rotational force to the venturi casing by means of kinetic energy received from the water. The first rotary vanes 18 each have a larger area than the second rotary vanes 19 and are arranged at equal angles in the circumferential direction of the venturi casing 16. The second rotary vanes 19 are each positioned between the first rotary vanes 18 and collide with the water passing between the first rotary vanes 18. The first and second rotary vanes 18 and 19 collide with the water passing through the venturi casing 16 and rotate the venturi casing 16 by means of kinetic energy received from the water.

The push-up vane 17 is a vane piece fixed to the outer peripheral surface of the venturi casing 16, and serves to raise the gas around the venturi casing upward of the inlet part 16a of the venturi casing when the venturi casing rotates. In other words, the gas that is stagnant around the venturi casing 16 is raised higher than the venturi casing so as to be sucked into the inlet part 16a more quickly.

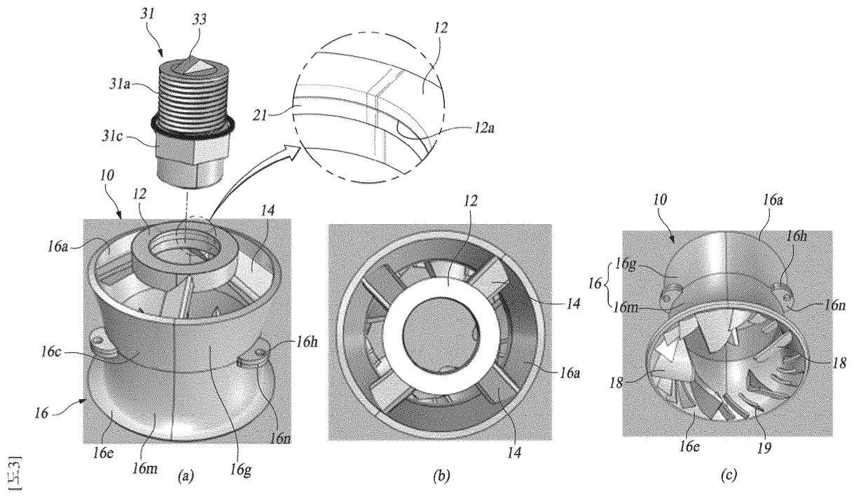

FIGS. 3(a) to 3(c) are views illustrating a modification of the sprinkler head device according to the first embodiment of the present disclosure.

Hereinafter, the same reference numerals as the above reference numerals indicate the same members having the same function.

Referring to the drawings, it can be seen that the venturi casing 16 is composed of an upper casing 16g and a lower casing 16m that are assembled to each other. The bottom of the upper casing 16g and the top of the lower casing 16m are coupled through coupling flanges 16h and 16n in a state of contact with each other. The assembly of the upper and lower casings 16g and 16m allows the combination of the upper casing 16g and the lower casing 16m to be implemented in various ways. For example, it is possible to ensure different sized lower casings to replace and use the lower casing 16m coupled to the upper casing 16g.

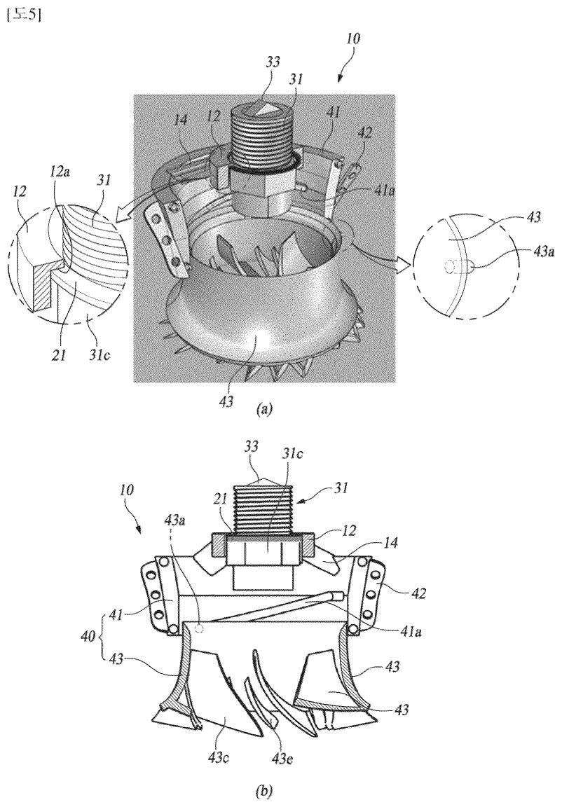

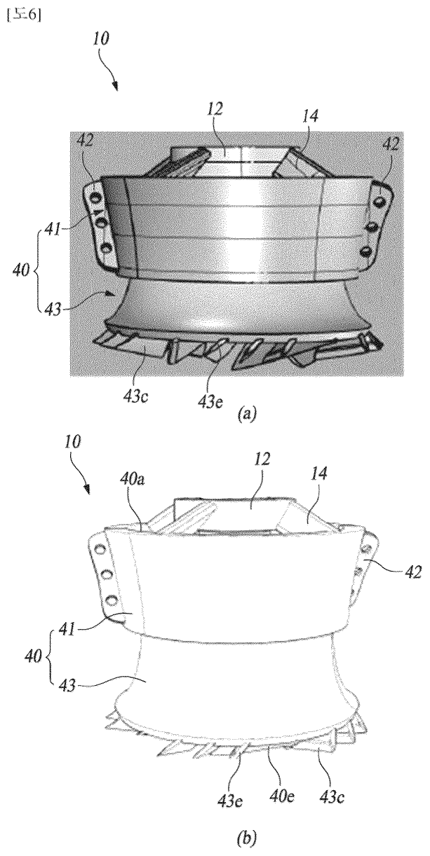

FIGS. 5(a) and 5(b) are views illustrating another modification of the sprinkler head device according to the first embodiment of the present disclosure. FIGS. 6(a) and 6(b) are views illustrating an exemplary use of the sprinkler head device illustrated in FIG. 5(a).

In the sprinkler head device 10 of FIGS. 5(a) and 5(b), a venturi casing 40 is composed of an upper casing 41 and a lower casing 43. The venturi casing 40 includes an inlet part 40a for sucking ambient gas therethrough, and an outlet part 40e for discharging water and gas mixed with water therethrough.

As illustrated in the drawings, the lower casing 43 may be partially accommodated inside the upper casing 41. That is, as illustrated in FIG. 6(a), the lower casing 43 is held in a state in which a portion thereof is accommodated inside the upper casing 41, and then moves down and extends by the action of hydraulic pressure when water is spouted. To this end, it goes without saying that the bottom of the upper casing 41 should have an inner diameter larger than the outer diameter of the top of the lower casing 43.

In addition, in order to support the lower casing 43 on the upper casing 41, the upper casing 41 has a spiral groove 41a formed on the inner peripheral surface thereof, and the lower casing 43 has a groove insertion protrusion 43a formed on the outer peripheral surface thereof.

The spiral groove 41a is a groove extending spirally on the inner peripheral surface of the upper casing 41, and consists of two grooves formed to face each other. The groove insertion protrusion 43a is a protrusion fixed to the outer peripheral surface of the lower casing 43, and is movable in the longitudinal direction of the spiral groove in a state in which it is accommodated in the spiral groove 41a. Thus, as illustrated in FIG. 6(a), the lower casing 43 inserted into the upper casing 41 descends and rotates at the same time when hydraulic pressure is applied thereto.

In order to prevent the lower casing 43 from being completely separated from the upper casing when the lower casing 43 falls in a straight line, the spiral groove 41a is provided and the lower casing 43 is designed to rotate while descending.

In addition, first and second rotary vanes 43c and 43e are provided inside the lower casing 43. The first and second rotary vanes 43c and 43e receive the kinetic energy of the water sprayed through the nozzle 31 so as to allow the venturi casing 40 to rotate.

Reference numeral 42 denotes a push-up vane. The push-up vane 42 plays the same role as the push-up vane (see 17 in FIG. 2(a)) described with reference to FIG. 2(a).

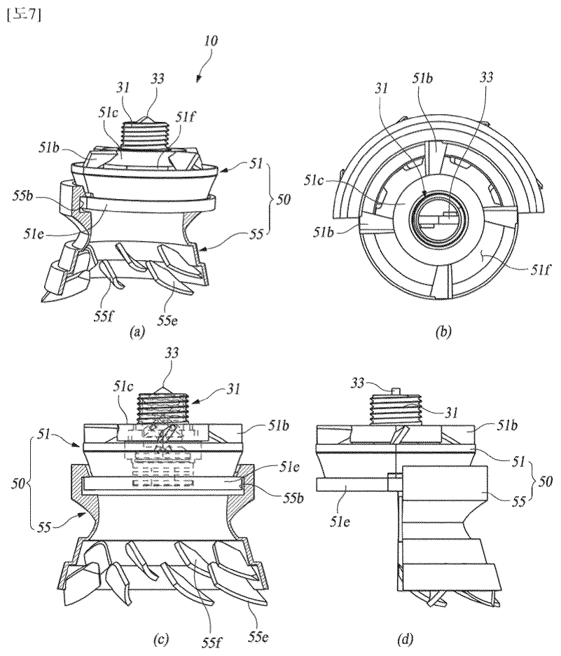

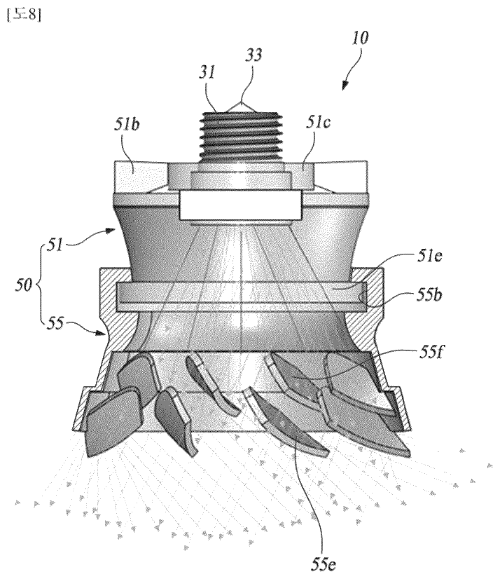

FIGS. 7(a) to 7(d) are views illustrating a configuration of a sprinkler head device according to a second embodiment of the present disclosure. FIG. 7(a) is a partially cutaway perspective view of the sprinkler head device, FIG. 7(b) is a partially cutaway top view of the sprinkler head device, and FIGS. 7(c) and 7(d) are partially cutaway front and side views of the sprinkler head device. FIG. 8 is a view schematically illustrating a state of operation of the sprinkler head device according to the second embodiment.

As illustrated in the drawings, the sprinkler head device, which is designated by reference numeral 10, according to the second embodiment includes a nozzle 31, a venturi casing 50, and first and second rotary vanes 55e and 55f.

The nozzle 31 has a vortex inductor 33 therein, and a description thereof is as given above.

The venturi casing 50 is latched to and supported by the nozzle 31. The venturi casing 50 allows the water sprayed from the nozzle to pass therethrough, generates negative pressure according to the Venturi effect while the water passes therethrough to suck ambient gas, and mixes the sucked gas with water to discharge a mixture thereof.

The venturi casing 50 is composed of a fixed casing 51 and a rotating casing 55. The fixed casing 51 is fixed to the nozzle 31 and provides an inlet 51f for introducing gas therethrough.

The fixed casing 51 is coupled to the nozzle 31 through a nozzle support ring 51c and a press-fit vane 51b, but does not rotate. The fixed casing 51 not only allows gas to flow downward through the inlet 51f, but also supports the rotating casing 55 rotatably. The configuration of the nozzle support ring 51c and the press-fit vane 51b is the same as the nozzle latch ring 12 and the press-fit vane 14 described with reference to FIG. 2(a).

To this end, the fixed casing 51 has a rotating ring 51e provided on the outer peripheral surface thereof. The rotating ring 51e is a ring-shaped member extending in the circumferential direction of the fixed casing 51. The rotating ring 51e has a certain cross-sectional shape along the extending direction thereof.

The rotating casing 55 is a member rotatably coupled to the fixed casing 51 and has a ring accommodation groove 55b formed on the inner peripheral surface thereof. The ring accommodation groove 55b is a circular groove for accommodating the rotating ring 51e. The rotating casing 55 is axially rotatable with the rotating ring 51e accommodated therein. In addition, the first and second rotary vanes 55e and 55f are provided inside the bottom of the lower casing 55. The first and second rotary vanes 55e and 55f rotate the rotating casing 55 by means of flow energy received from the water spouted from the nozzle.

Although specific embodiments have been described in detail above, it will be understood by those skilled in the art that the present disclosure is not limited to the above embodiments and various modifications may be made without departing from the spirit and scope of the disclosure.

1. A sprinkler head device for removal of smoke and toxic gas equipped with a rotary venturi, comprising:
a nozzle configured to spray water supplied from the outside;
a venturi casing configured to receive, through an inlet part thereof, the water sprayed from the nozzle to allow the same to pass therethrough in a state in which the venturi casing is rotatably supported by the nozzle, to generate negative pressure according to a Venturi effect while the water passes therethrough to suck ambient gas, and to mix the sucked gas with the water to discharge a mixture thereof;
a rotary vane fixed to the inside of the venturi casing and configured to transmit rotational force to the venturi casing by means of kinetic energy received from water; and
a press-fit vane positioned at an upstream end of the venturi casing and configured to draw in ambient gas and press the same into the venturi casing when the venturi casing rotates.

2. The sprinkler head device according to claim 1, further comprising a nozzle latch ring fixed to the upstream end of the venturi casing via the press-fit vane, the nozzle latch ring being in the form of a ring and being is rotatably latched to and supported by the nozzle while wrapping the nozzle.

3. The sprinkler head device according to claim 1, further comprising a push-up vane provided on an outer peripheral surface of the venturi casing to guide gas around the venturi casing toward the inlet part of the venturi casing.

4. The sprinkler head device according to claim 1, wherein the venturi casing is composed of an upper casing and a lower casing that are assembled to each other.

5. The sprinkler head device according to claim 4, wherein the lower casing is partially accommodated inside the upper casing, and then extends outward of the upper casing by the action of hydraulic pressure when water is sprayed.

6. The sprinkler head device according to claim 5, wherein:
the upper casing has a spiral groove formed thereon to extend spirally; and
the lower casing has a groove insertion protrusion formed to be movable along the spiral groove in a state in which the groove insertion protrusion is fitted into the spiral groove.

7. A sprinkler head device for removal of smoke and toxic gas equipped with a rotary venturi, comprising:
a nozzle configured to spray water supplied from the outside;
a venturi casing supported by the nozzle, and configured to allow the water sprayed from the nozzle to pass therethrough, to generate negative pressure according to a Venturi effect while the water passes therethrough to suck ambient gas, and to mix the sucked gas with the water to discharge a mixture thereof, wherein the venturi casing has a fixed casing fixed to the nozzle and providing an inlet for introducing gas therethrough, and a rotating casing rotatably coupled to the fixed casing; and
a rotary vane fixed to the inside of the rotating casing and configured to rotate the rotating casing by means of kinetic energy received from the water sprayed from the nozzle.

8. The sprinkler head device according to claim 7, wherein:
the fixing casing has a rotating ring formed on an outer peripheral surface thereof to extend in a circumferential direction of the fixed casing; and
the rotating casing has a ring accommodation groove provided on an inner peripheral surface thereof to accommodate the rotating ring and receive support force from the rotating ring.

9. The sprinkler head device according to claim 1, wherein the nozzle has a built-in vortex inductor therein for swirling a flow of water passing through the nozzle.

10. The sprinkler head device according to claim 7, wherein the nozzle has a built-in vortex inductor therein for swirling a flow of water passing through the nozzle.
